(19) United States
(12) Patent Application Publication
(10) Pub. No.: US 2025/0384188 A1
(43) Pub. Date: Dec. 18, 2025

(54) Using Artificial Intelligence to Generate 3D Artifacts and Model Based Definition from 2D Drawings

(71) Applicant: The Boeing Company, Arlington, VA (US)

(72) Inventors: Amir Afrasiabi, Fircrest, WA (US); Sina Rafati, Cedar Park, TX (US); Brett M. Factory, Mountlake Terrace, WA (US); Andrew J. Scott, Seattle, WA (US)

(21) Appl. No.: 19/203,849

(22) Filed: May 9, 2025

Related U.S. Application Data
(60) Provisional application No. 63/660,435, filed on Jun. 14, 2024.

(51) Int. Cl. G06F 30/27; B29C 64/393; B33Y 50/02; G06F 30/15

(52) U.S. Cl. CPC G06F 30/27; B29C 64/393; B33Y 50/02; G06F 30/15

(57) ABSTRACT

Generating a 3D model from 2D drawings is provided. The method comprises extracting, by a design parser, content from 2D engineering drawings of an assembly and comparing the extracted content to a bill of materials corresponding to a 3D computer assisted design (CAD) model of the assembly to identify missing components from the 3D CAD model. Responsive to identifying missing components, 3D representations of the missing components are modeled based on the 2D engineering drawings, and metadata and textual information related to the 2D engineering drawings. The 3D representations of the missing components are incorporated into the 3D CAD model of the assembly to create a complete 3D CAD model. A manufacturing process for the assembly is then controlled according to the complete 3D CAD model.

### CROSS-REFERENCE TO RELATED APPLICATION

This application claims the benefit of U.S. Provisional Patent Application Ser. No. 63/660,435, filed Jun. 14, 2024, and entitled “Using Artificial Intelligence to Generate 3D Artifacts and Model Based Definition from 2D Drawings,” which is incorporated herein by reference in its entirety.

### BACKGROUND INFORMATION

### 1. Technical Field

The present disclosure relates generally to computer modeling, and more specifically to generating 3D representations from 2D drawings.

### 2. Background

One of the key requirements for having a Model-Based Engineering manufacturing and production system is to have a fully defined Model-Based Design (MBD) wherein each Computer Aided Design (CAD) artifact is a true representative of actual physical objects. Manufacturing and production companies are struggling with switching from traditional drafting drawings and installation/production instruction to MBD and Model-Based Instruction (MBI).

### SUMMARY

An illustrative embodiment provides a computer-implemented method for generating a 3D model from 2D drawings. The method comprises extracting, by a design parser, content from 2D engineering drawings of an assembly and comparing the extracted content to a bill of materials corresponding to a 3D computer assisted design (CAD) model of the assembly to identify missing components from the 3D CAD model. Responsive to identifying missing components, 3D representations of the missing components are modeled based on the 2D engineering drawings, and metadata and textual information related to the 2D engineering drawings. The 3D representations of the missing components are incorporated into the 3D CAD model of the assembly to create a complete 3D CAD model. A manufacturing process for the assembly is then controlled according to the complete 3D CAD model.

Another illustrative embodiment provides a system for generating a 3D model from 2D drawings. The system comprises a storage device that stores program instructions and one or more processors operably connected to the storage device and configured to execute the program instructions to cause the system to: extract, by a design parser, content from 2D engineering drawings of an assembly; compare the extracted content to a bill of materials corresponding to a 3D computer assisted design (CAD) model of the assembly to identify missing components from the 3D CAD model; responsive to identifying missing components, model 3D representations of the missing components based on the 2D engineering drawings, and metadata and textual information related to the 2D engineering drawings; incorporate the 3D representations of the missing components into the 3D CAD model of the assembly to create a complete 3D CAD model; and control a manufacturing process for the assembly according to the complete 3D CAD model.

An illustrative embodiment provides a computer program product for generating a 3D model from 2D drawings. The computer program product comprises a computer-readable storage medium having program instructions embodied thereon to perform the operations of: extracting, by a design parser, content from 2D engineering drawings of an assembly; comparing the extracted content to a bill of materials corresponding to a 3D computer assisted design (CAD) model of the assembly to identify missing components from the 3D CAD model; responsive to identifying missing components, modeling 3D representations of the missing components based on the 2D engineering drawings, and metadata and textual information related to the 2D engineering drawings; incorporating the 3D representations of the missing components into the 3D CAD model of the assembly to create a complete 3D CAD model; and controlling a manufacturing process for the assembly according to the complete 3D CAD model.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts a block diagram of a 3D representation generator in accordance with an illustrative embodiment;

FIG. 2 depicts an example of a 2D engineering drawing of an assembly that includes a component that is missing from a 3D CAD model;

FIG. 3 depicts an example of a 3D CAD model to which a missing component is added in accordance with an illustrative embodiment;

FIG. 4 depicts a method for generating 3D representations from 2D drawings using CAD macros in accordance with an illustrative embodiment;

FIG. 5 depicts a method for generating 3D representations from 2D drawings using CAD UV map unwrapping in accordance with an illustrative embodiment;

FIG. 6 depicts a first phase of training a 3D semi-generative AI model for generating 3D representations from 2D drawings in accordance with an illustrative embodiment;

FIG. 7 depicts a second phase of training a 3D semi-generative AI model for generating 3D representations from 2D drawings in accordance with an illustrative embodiment;

FIG. 8 depicts a third phase of training a 3D semi-generative AI model for generating 3D representations from 2D drawings in accordance with an illustrative embodiment;

FIG. 9 depicts a method for generating 3D representations from 2D drawings using a 3D semi-generative AI model in accordance with an illustrative embodiment;

FIG. 10 depicts a flowchart illustrating a process for generating a 3D model from 2D drawings in accordance with an illustrative embodiment;

FIG. 11 depicts a process for modelling 3D representations of the missing components based on 2D engineering drawings in accordance with an illustrative embodiment;

FIG. 12 depicts an alternate process for modelling 3D representations of the missing components based on 2D engineering drawings in accordance with an illustrative embodiment.

FIG. 13 depicts an alternate process for modelling 3D representations of the missing components based on 2D engineering drawings in accordance with an illustrative embodiment

FIG. 14 depicts a flowchart illustrating a process for training a semi-generative AI model in accordance with an illustrative embodiment

FIG. 15 depicts a flowchart illustrating a process of for modelling 3D representations of the missing components based on 2D engineering drawings with a trained semi-generative AI model in accordance with an illustrative embodiment; and

FIG. 16 is an illustration of a block diagram of a data processing system in accordance with an illustrative embodiment.

### DETAILED DESCRIPTION

The illustrative embodiments recognize and take into account that one of the key requirements for having a Model-Based Engineering manufacturing and production system is to have a fully defined Model-Based Design (MBD) which means each Computer Aided Design (CAD) artifacts are true representative of actual physical objects.

The illustrative embodiments also recognize and take into account that the majority of aerospace and manufacturing parts and standards do not have 3D representation and/or real images of the parts. Operation teams need to have a visual reference of the target part or assembly that is being referenced on 2D drawing.

The illustrative embodiments provide a method of using Generative Artificial Intelligence to digest scattered production artifacts and documents such as 2D drawings, installation steps, specifications, standards and requirements to generate MBD artifacts for each part number and sub-assemblies/assemblies.

The illustrative embodiments also provide methods to teach AI to understand installation steps and requirements and visualize them on MBD artifacts.

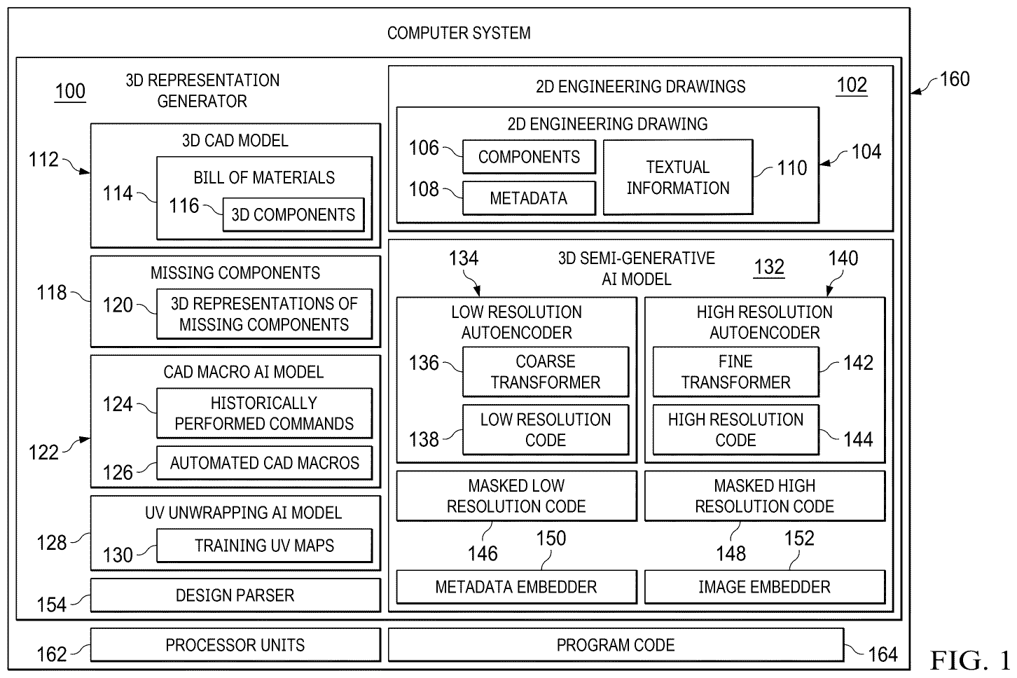

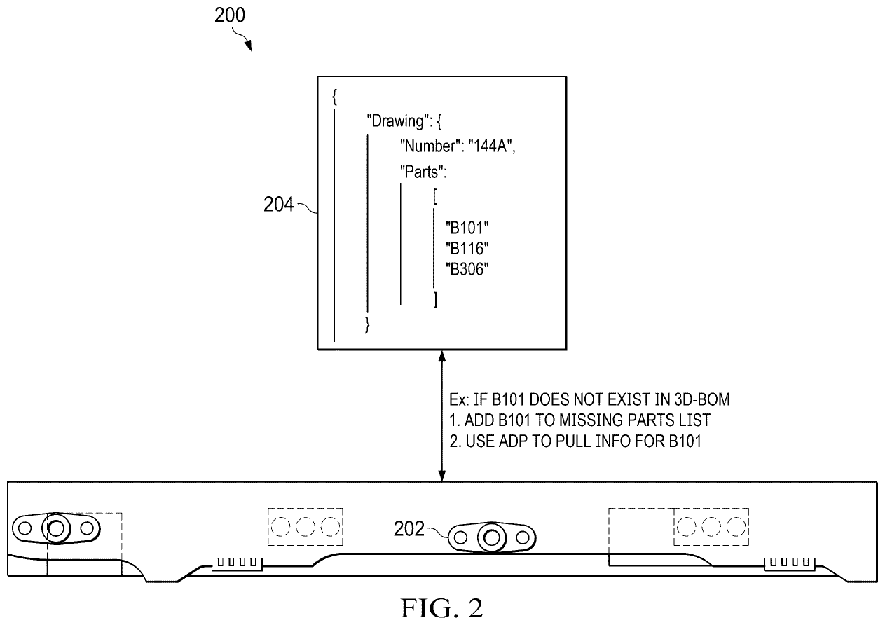

FIG. 1 is a block diagram of a 3D representation generator depicted in accordance with an illustrative embodiment. 3D representation generator 100 compares a 3D CAD model 112 to 2D engineering drawings 102 to determine if there are any missing components 118 that are not present in the 3D CAD model 112 that are included in the 2D engineering drawings 102. (See FIG. 2).

Each 2D engineering drawing 104 among 2D engineering drawings 102 comprises a number of components 106. Each 2D engineering drawing 104 might also comprise metadata 108 and textual information 110 that can be used to help generate 3D representations 120 of missing components.

The metadata 108 can be extracted from the 2D engineering drawings 102 by design parser 154. Design parser 154 reads and interprets information from 2D engineering drawings 102 regarding limitations of the target object to be generated (missing components 118). Design parser 154 is also able to cross-reference textual information 110.

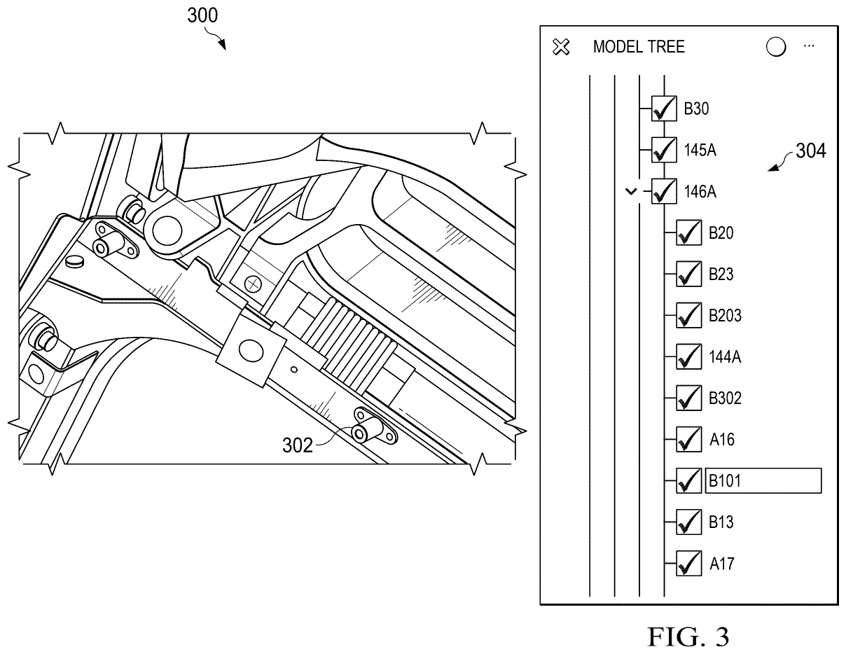

3D representation generator 100 might use a number of alternate artificial intelligence (AI) models to generate the 3D representations 120 of the missing components 118 for inclusion into 3D CAD model 112. (See FIG. 3).

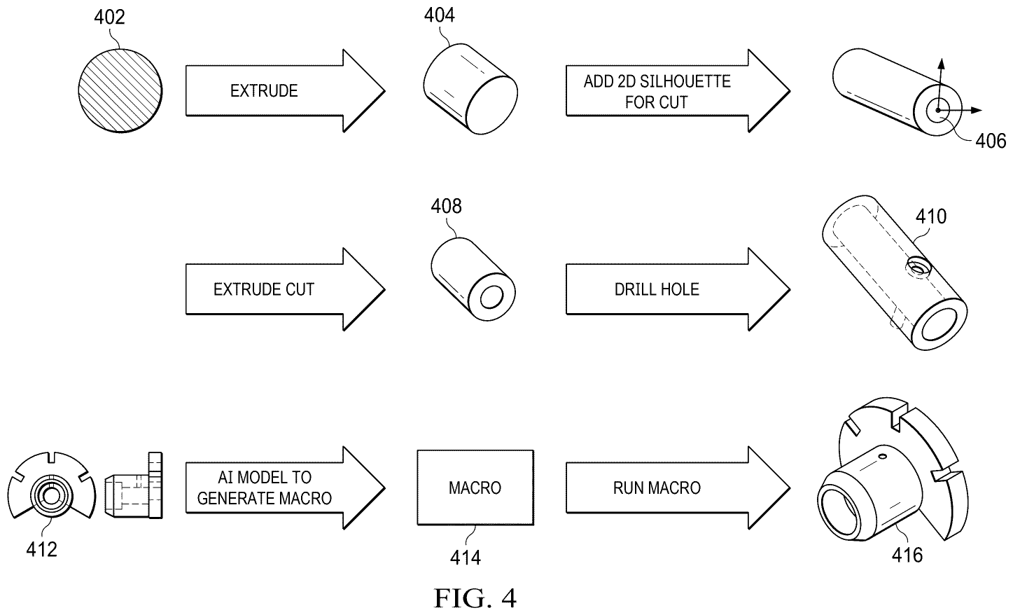

One model is CAD macro AI model 122. This model is trained according to historically performed commands 124 made by humans when manually generating 3D models from 2D drawings. Based on these historically performed commands 124, CAD macro AI model 122 generate automated CAD macros that can be run to generate the 3D representations 120 of missing components 118 from 2D engineering drawings 102. (See FIG. 4).

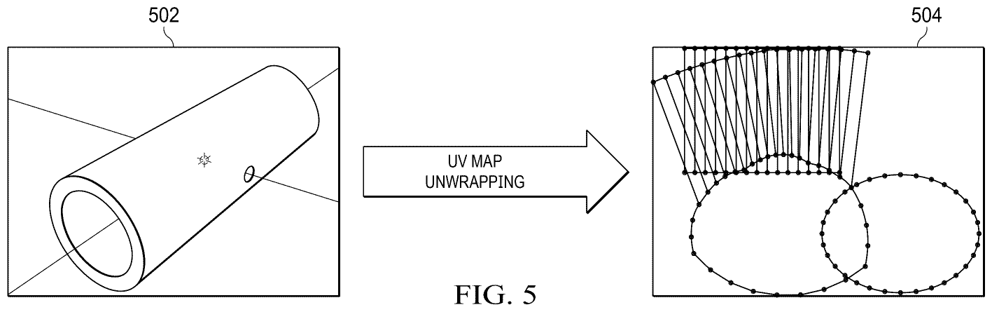

Another model is UV unwrapping model 128 which utilizes a number of training UV maps 130. UV mapping projects a 3D model's surface to a 2D image for mapping. In UV mapping and unwrapping, U represents the horizontal axis, and V represent the vertical axis in two dimensions because X, Y, and Z are used to denote axes in 3D modeling. (See FIG. 5).

Another model is a 3D semi-generative AI model 132, which comprises a low resolution autoencoder 134 and a high resolution autoencoder 140. Low resolution autoencoder 134 comprises a coarse transformer 136 that can generate low resolution code 138 from masked low resolution code 146 with the help of embeddings provided by a metadata embedder 150 and image embedder 152.

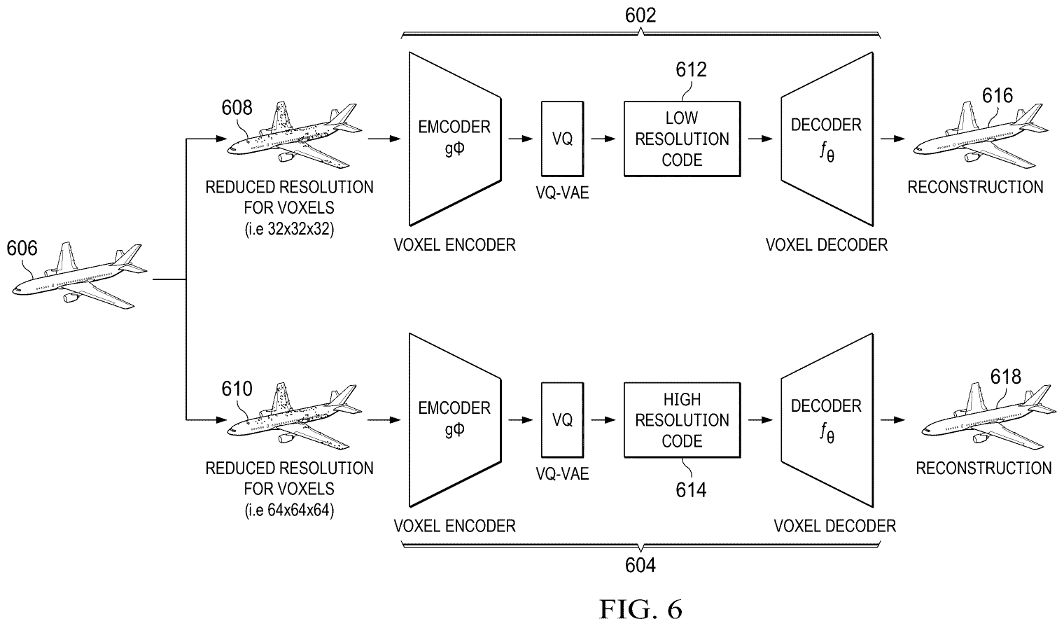

High resolution autoencoder 140 comprises a fine transformer 142 that can generate high resolution code 144 from masked high resolution code 148 with the help of the low resolution code 138 generated by the low resolution autoencoder 134. (See FIGS. 6-9).

3D representation generator 100 can be implemented in software, hardware, firmware, or a combination thereof. When software is used, the operations performed by 3D representation generator 100 can be implemented in program code configured to run on hardware, such as a processor unit. When firmware is used, the operations performed by 3D representation generator 100 can be implemented in program code and data and stored in persistent memory to run on a processor unit. When hardware is employed, the hardware can include circuits that operate to perform the operations in 3D representation generator 100.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 160 is a physical hardware system and includes one or more data processing systems. When more than one data processing system is present in computer system 160, those data processing systems are in communication with each other using a communications medium. The communications medium can be a network. The data processing systems can be selected from at least one of a computer, a server computer, a mobile device such as a tablet computer, or some other suitable data processing system.

As depicted, computer system 160 includes a number of processor units 162 that are capable of executing program code 164 implementing processes in the illustrative examples. As used herein, a processor unit in the number of processor units 162 is a hardware device and is comprised of hardware circuits such as those on an integrated circuit that respond and process instructions and program code that operate a computer. When a number of processor units 162 execute program code 164 for a process, the number of processor units 162 is one or more processor units that can be on the same computer or on different computers. In other words, the process can be distributed between processor units on the same or different computers in a computer system. Further, the number of processor units 162 can be of the same type or different types of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

FIG. 2 depicts an example of a 2D engineering drawing of an assembly that includes a component that is missing from a 3D CAD model. In this example, bracket 202 is part of 2D engineering drawing 200 but is currently missing from a corresponding 3D CAD model and must be added to the 3D CAD model to complete the model-based definition (MBD) of the assembly, as shown in FIG. 3.

The 2D engineering drawing 200 is compared to a bill of materials (BOM) of a corresponding 3D CAD model for the assembly in question to identify any components missing from the MBD in the CAD model. The 3D representation generator of the illustrative embodiments extracts content from the 2D engineering drawing 200 using automatic data processing (ADP). The extracted content might include, e.g., flag notes, sub-assemblies, dimensions, GD&T (Geometric Dimensioning and Tolerance) symbols, etc. If all components extracted from the 2D engineering are present in the BOM, the MBD of the assembly is complete. However, if any components in the 2D engineering drawing 200 are missing from the BOM of the 3D CAD model the MBD is incomplete, and those missing components must be added to the MBD.

JSON file 204 contains ADP extracted metadata listing the components and their respective labels found in 2D engineering drawing 200. JSON file 204 represents a manufacturing BOM (MBOM), which can be compared to an electronic BOM (EBOM) such as EBOM 304 in FIG. 3. If the MBOM 204 and EBOM 304 match, the MBD is complete. In the present example, bracket 202 is missing from the 3D CAD model and must be added.

FIG. 3 depicts an example of a 3D CAD model to which a missing component is added in accordance with an illustrative embodiment. Upon discovery of a missing component, the 3D representation generator goes deeper into the corresponding 2D engineering drawing and engineering references and specification to model the missing component 302, which is then added to the 3D CAD model 300.

In addition to modelling the missing component 302 in 3D, the 3D representation generator also generates model-based instructions (MBI) describing the proper installation sequence for adding that components to the 3D CAD model 300 based on textual information, in the engineering specification.

FIG. 4 depicts a method for generating 3D representations from 2D drawings using CAD macros in accordance with an illustrative embodiment. In the approach illustrated in FIG. 4, numerous examples of manual creation of 3D objects from 2D drawings are recorded.

These recorded operations are used to learn the types of actions taken by human users using CAD systems to generate 3D models for many types of shapes. In the present example, a hollow cylinder with a through hole 410 is generated from an initial circle 402. Starting with the initial circle 402, a solid cylinder 404 is extruded into three dimensions. Next a 2D silhouette 406 for a cut is added to the cylinder. The cut is then extruded to produce a hollow cylinder 408. Next through hole 410 is drilled through the hollow cylinder. This sequence can be recorded into a macro. A similar process can be performed for a number of other shapes such as cones, cubes, etc., of various levels of complexity with special features, all of which can be recorded in macros.

A large number of such CAD macros can be used to train an AI model to generate an automated macro 414 when presented with a 2D engineering drawing 412. This automated macro 414 is then used to generate a 3D representation of the part specified in the 2D engineering drawing 412.

FIG. 5 depicts a method for generating 3D representations from 2D drawings using CAD UV map unwrapping in accordance with an illustrative embodiment. UV unwrapping is the process of flattening the surface of a 3D model 502 onto a 2D plane to create a UV map 504. This flattening allows a 2D image (texture) to be accurately applied to the 3D model. This process is similar to peeling an orange and laying its peel flat or representing a globe as a flat map. Specialized algorithms help in minimizing stretching and distortion during this step.

The term “UV” refers to the axes of the 2D texture coordinates (U for horizontal, V for vertical), distinguishing them from the 3D model's X, Y, and Z axes.

An AI model can be trained on a number of such unwrapped UV maps to extrapolate how to reverse the process to construct a 3D model from a 2D representation.

FIG. 6 depicts a first phase of training a 3D semi-generative AI model for generating 3D representations from 2D drawings in accordance with an illustrative embodiment. This first phase of training involves training a low resolution autoencoder 602 and a high resolution autoencoder 604 to reconstruct a 3D model 606 from reduced resolution representations 608 and 610.

In the present example, the first reduced resolution representation 608 of full resolution 3D model 606 comprises a voxel resolution of 32×32×32, which is fed as input data into low resolution autoencoder 602. The second reduced resolution representation 610 has a higher relative resolution, 64×64×64, than the first reduced resolution representation 608 but is still of lower resolution than the original 3D model 606. Both autoencoders might be, e.g., vector-quantized variational autoencoders (VQ-VAE).

Low resolution encoder 602 encodes the first reduced resolution representation 608 into low resolution code 612, which is then decoded to produce a reconstruction 616 of the original 3D model 606. The high resolution autoencoder 604 encodes the second reduced resolution representation 610 into high resolution code 614, which is then decoded to produce a second reconstruction 618 of the original 3D model 606. Through numerous iterations, both autoencoders are trained to reconstruct the full resolution of the original 3D model 606 despite starting with respective reduced resolution representations 608, 610 of that model.

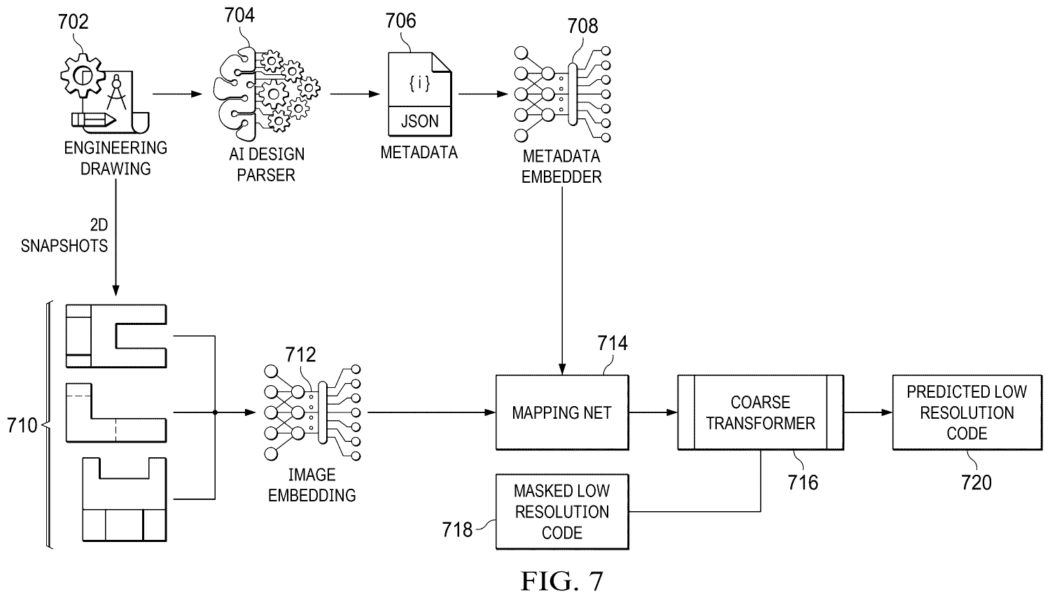

FIG. 7 depicts a second phase of training a 3D semi-generative AI model for generating 3D representations from 2D drawings in accordance with an illustrative embodiment. After the low resolution autoencoder is train to reconstruct the original full resolution model from low resolution code, it is then trained to predict low resolution code 720 from partially masked low resolution code 718.

To assist with this reconstruction, an AI design parser 704 extracts metadata 706 from a 2D engineering drawing 702. A metadata embedder 708 embeds this extracted metadata 706 to a mapping network 714. Similarly, 2D engineering drawing 702 might comprise multiple images 710 of the object or assembly in questions such as, for example, a top view, bottom view, right side, left side, etc. These different views 710 are embedded into an image embedding, which is also fed into the mapping network for cross-reference with the metadata 706.

A coarse transformer 716 in the low resolution autoencoder applies these metadata and image embedding from the mapping network 714 to the partially masked low resolution code 718 to learn to predict unmasked low resolution code 720.

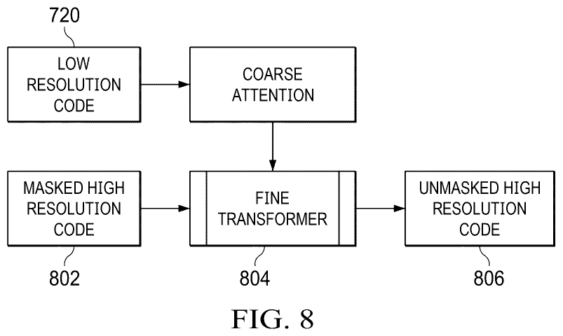

FIG. 8 depicts a third phase of training a 3D semi-generative AI model for generating 3D representations from 2D drawings in accordance with an illustrative embodiment. One the coarse transformer has been trained to predict unmasked low resolution code 720 from partially masked low resolution code, that predicted low resolution code 720 can then be used to train a fine transformer 804 in the high resolution autoencoder to predict unmasked high resolution code 806 from partially masked high resolution code 802.

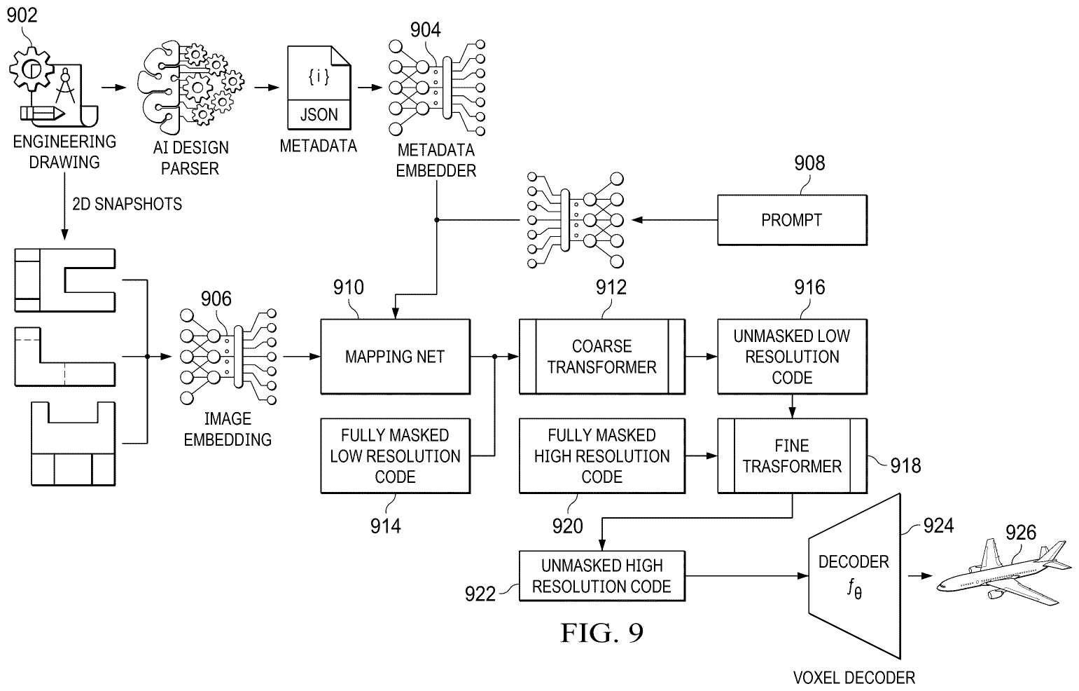

FIG. 9 depicts a method for generating 3D representations from 2D drawings using a 3D semi-generative AI model in accordance with an illustrative embodiment. After the coarse and fine transformers are trained as described above, they can be combined into a single process flow to generate a high resolution 3D model 926 from a 2D engineering drawing 902.

Similar to the process shown in FIG. 7, metadata embeddings 904 and image embeddings 906 generated from the 2D engineering drawing 902 are fed into a mapping network 910 However, in this application at least one prompt 908 is also fed into the mapping network 910. Prompt 908 might include, e.g., a specific material to be used for building the object or assembly modeled in 3D, which acts as a constraint in constructing the 3D model 926.

The metadata embeddings 904, image embeddings 906, and prompt 908 assist the trained coarse transformer 912 to predict unmasked low resolution code 916 from fully masked low resolution code 914. The predicted unmasked low resolution code 916 is then used by the trained fine transformer 918 to predict unmasked high resolution code 922 from fully masked high resolution code 920.

A voxel decoder 924 then decodes the predicted unmasked high resolution code 922 to generate 3D model 926.

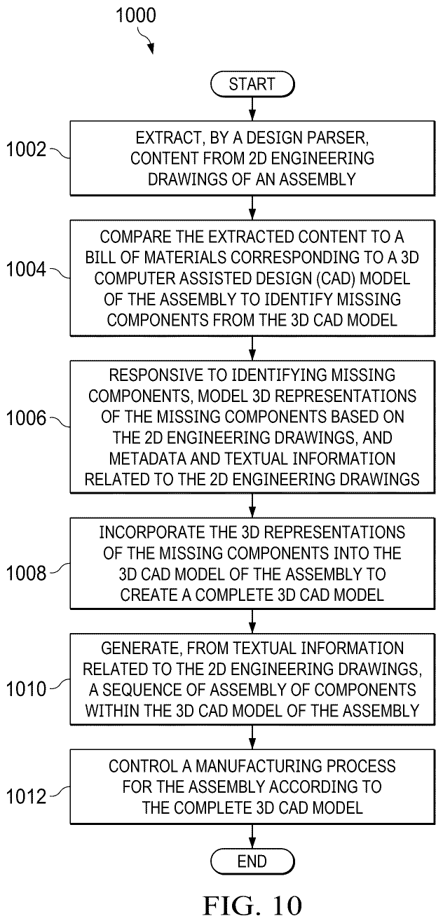

FIG. 10 depicts a flowchart illustrating a process for generating a 3D model from 2D drawings in accordance with an illustrative embodiment. Process 1000 can be implemented in 3D representation generator 100 in FIG. 1.

Process 1000 begins by extracting, by a design parser, content from two-dimensional (2D) engineering drawings of an assembly (operation 1002).

The extracted content is compared to a bill of materials (BOM) corresponding to a three-dimensional (3D) computer assisted design (CAD) model of the assembly to identify missing components from the 3D CAD model (operation 1004).

Responsive to identifying missing components, process 1000 models 3D representations of the missing components based on the 2D engineering drawings, and metadata and textual information related to the 2D engineering drawings (operation 1006).

The 3D representations of the missing components are incorporated into the 3D CAD model of the assembly to create a complete 3D CAD model (operation 1008).

Process 1000 may generate, from textual information related to the 2D engineering drawings, a sequence of assembly of components within the 3D CAD model of the assembly (operation 1010).

Process 1000 controls a manufacturing process for the assembly according to the complete 3D CAD model (operation 1012). Process 1000 then ends.

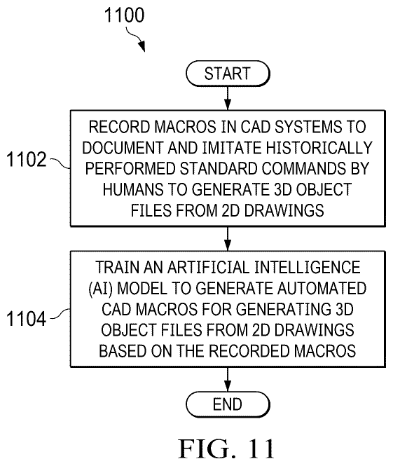

FIG. 11 depicts a process for modelling 3D representations of the missing components based on 2D engineering drawings in accordance with an illustrative embodiment. Process 1100 is a detailed example of an implementation of operation 1006 in FIG. 10.

Process 1100 begins by recording macros in CAD systems to document and imitate historically performed standard commands by humans to generate 3D object files from 2D drawings (operation 1102).

Process 1100 trains an artificial intelligence (AI) model to generate automated CAD macros for generating 3D object files from 2D drawings based on the recorded macros (operation 1104). Process 1100 then ends.

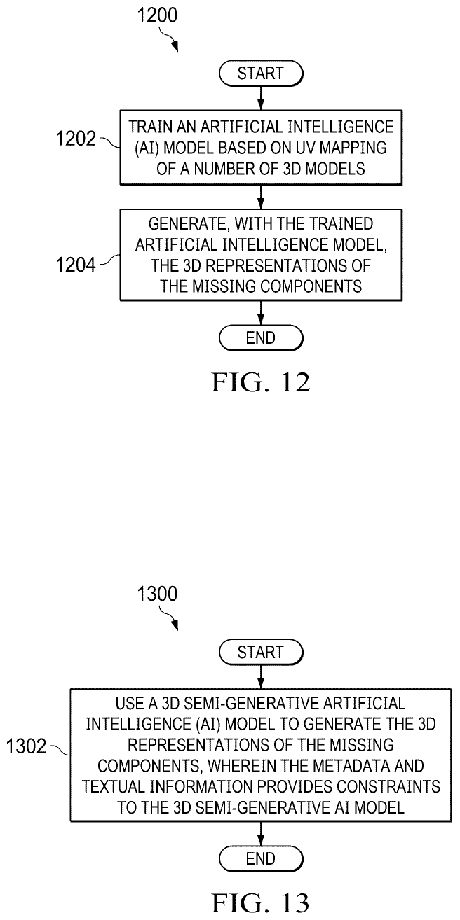

FIG. 12 depicts an alternate process for modelling 3D representations of the missing components based on 2D engineering drawings in accordance with an illustrative embodiment. Process 1200 is a detailed example of an implementation of operation 1006 in FIG. 10.

Process 1200 begins by training an artificial intelligence (AI) model based on UV mapping of a number of 3D models (operation 1202).

Process 1200 generates, with the trained artificial intelligence model, the 3D representations of the missing components (operation 1204). Process 1200 then ends.

FIG. 13 depicts an alternate process for modelling 3D representations of the missing components based on 2D engineering drawings in accordance with an illustrative embodiment. Process 1300 is a detailed example of an implementation of operation 1006 in FIG. 10.

Process 1300 comprises using a 3D semi-generative artificial intelligence (AI) model to generate the 3D representations of the missing components, wherein the metadata and textual information provides constraints to the 3D semi-generative AI model (operation 1302).

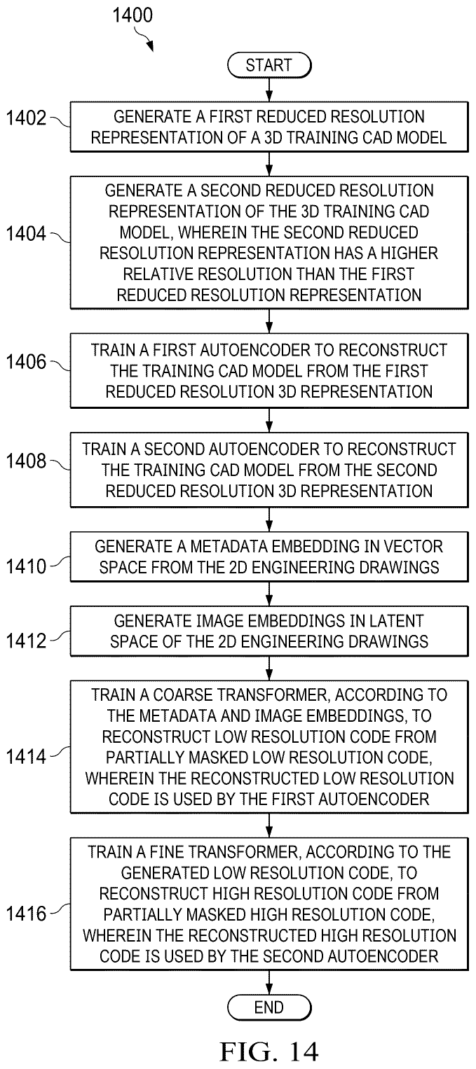

FIG. 14 depicts a flowchart illustrating a process for training a semi-generative AI model in accordance with an illustrative embodiment. Process 1400 is an example of training a semi-generative AI model such as the one used in process 1300.

Process 1400 begins by generating a first reduced resolution representation of a 3D training CAD model (operation 1402) and generating a second reduced resolution representation of the 3D training CAD model, wherein the second reduced resolution representation has a higher relative resolution than the first reduced resolution representation (operation 1404).

A first autoencoder is trained to reconstruct the training CAD model from the first reduced resolution 3D representation (operation 1406). A second autoencoder to reconstruct the training CAD model from the second reduced resolution 3D representation (operation 1408).

A metadata embedding is generated in vector space from the 2D engineering drawings (operation 1410). Image embeddings are generated in latent space of the 2D engineering drawings (operation 1412).

A coarse transformer is trained according to the metadata and image embeddings to reconstruct low resolution code from partially masked low resolution code, wherein the reconstructed low resolution code is used by the first autoencoder (operation 1414).

A fine transformer is then trained according to the generated low resolution code to reconstruct high resolution code from partially masked high resolution code, wherein the reconstructed high resolution code is used by the second autoencoder (operation 1416). Process 1400 then ends.

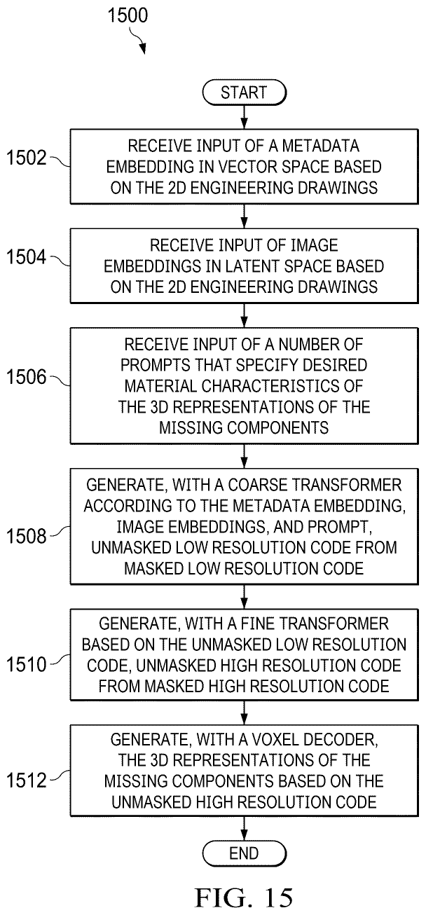

FIG. 15 depicts a flowchart illustrating a process of for modelling 3D representations of the missing components based on 2D engineering drawings with a trained semi-generative AI model in accordance with an illustrative embodiment. Process 1500 is a detailed example of the operation of a trained semi-generative AI model such as the one used in process 1300.

Process 1500 begins by the receiving input of a metadata embedding in vector space based on the 2D engineering drawings (operation 1502) and receiving input of image embeddings in latent space based on the 2D engineering drawings (operation 1504).

The semi-generative AI model also receives input of a number of prompts that specify desired material characteristics of the 3D representations of the missing components (operation 1506).

A coarse transformer generates, according to the metadata embedding, image embeddings, and prompt, unmasked low resolution code from masked low resolution code (operation 1508).

A fine transformer generates, based on the unmasked low resolution code, unmasked high resolution code from masked high resolution code (operation 1510).

A voxel decoder generates the 3D representations of the missing components based on the unmasked high resolution code (operation 1512). Process 1500 then ends.

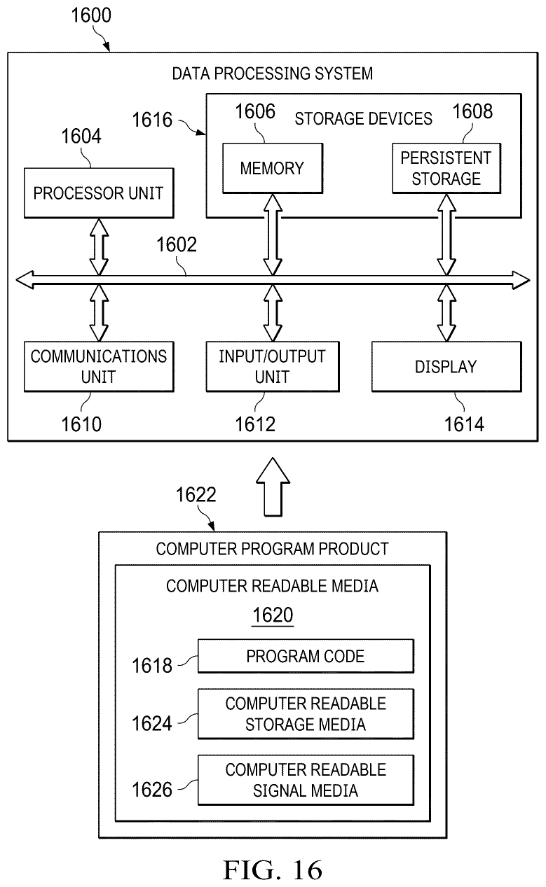

Turning now to FIG. 16, an illustration of a block diagram of a data processing system is depicted in accordance with an illustrative embodiment. Data processing system 1600 may be used to implement computer system 160 in FIG. 1. In this illustrative example, data processing system 1600 includes communications framework 1602, which provides communications between processor unit 1604, memory 1606, persistent storage 1608, communications unit 1610, input/output (I/O) unit 1612, and display 1614. In this example, communications framework 1602 takes the form of a bus system.

Processor unit 1604 serves to execute instructions for software that may be loaded into memory 1606. Processor unit 1604 may be a number of processors, a multi-processor core, or some other type of processor, depending on the particular implementation. In an embodiment, processor unit 1604 comprises one or more conventional general-purpose central processing units (CPUs). In an alternate embodiment, processor unit 1604 comprises one or more graphical processing units (GPUS).

Memory 1606 and persistent storage 1608 are examples of storage devices 1616. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1616 may also be referred to as computer-readable storage devices in these illustrative examples. Memory 1606, in these examples, may be, for example, a random access memory or any other suitable volatile or non-volatile storage device. Persistent storage 1608 may take various forms, depending on the particular implementation.

For example, persistent storage 1608 may contain one or more components or devices. For example, persistent storage 1608 may be a hard drive, a flash memory, a rewritable optical disk, a rewritable magnetic tape, or some combination of the above. The media used by persistent storage 1608 also may be removable. For example, a removable hard drive may be used for persistent storage 1608. Communications unit 1610, in these illustrative examples, provides for communications with other data processing systems or devices. In these illustrative examples, communications unit 1610 is a network interface card.

Input/output unit 1612 allows for input and output of data with other devices that may be connected to data processing system 1600. For example, input/output unit 1612 may provide a connection for user input through at least one of a keyboard, a mouse, or some other suitable input device. Further, input/output unit 1612 may send output to a printer. Display 1614 provides a mechanism to display information to a user.

Instructions for at least one of the operating system, applications, or programs may be located in storage devices 1616, which are in communication with processor unit 1604 through communications framework 1602. The processes of the different embodiments may be performed by processor unit 1604 using computer-implemented instructions, which may be located in a memory, such as memory 1606.

These instructions are referred to as program code, computer-usable program code, or computer-readable program code that may be read and executed by a processor in processor unit 1604. The program code in the different embodiments may be embodied on different physical or computer-readable storage media, such as memory 1606 or persistent storage 1608.

Program code 1618 is located in a functional form on computer-readable media 1620 that is selectively removable and may be loaded onto or transferred to data processing system 1600 for execution by processor unit 1604. Program code 1618 and computer-readable media 1620 form computer program product 1622 in these illustrative examples. In one example, computer-readable media 1620 may be computer-readable storage media 1624 or computer-readable signal media 1626.

In these illustrative examples, computer-readable storage media 1624 is a physical or tangible storage device used to store program code 1618 rather than a medium that propagates or transmits program code 1618. Computer readable storage media 1624, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 1618 may be transferred to data processing system 1600 using computer-readable signal media 1626. Computer-readable signal media 1626 may be, for example, a propagated data signal containing program code 1618. For example, computer-readable signal media 1626 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1600 are not meant to provide architectural limitations to the manner in which different embodiments may be implemented. The different illustrative embodiments may be implemented in a data processing system including components in addition to or in place of those illustrated for data processing system 1600. Other components shown in FIG. 16 can be varied from the illustrative examples shown. The different embodiments may be implemented using any hardware device or system capable of running program code 1618.

As used herein, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

As used herein, “a number of” when used with reference to items, means one or more items. For example, “a number of different types of networks” is one or more different types of networks. In illustrative example, a “set of” as used with reference items means one or more items. For example, a set of metrics is one or more of the metrics.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method for generating a 3D model from 2D drawings, the method comprising:
using a number of processors to perform:
extracting, by a design parser, content from 2D engineering drawings of an assembly;
comparing the extracted content to a bill of materials corresponding to a 3D computer assisted design (CAD) model of the assembly to identify missing components from the 3D CAD model;
responsive to identifying missing components, modeling 3D representations of the missing components based on the 2D engineering drawings, and metadata and textual information related to the 2D engineering drawings;
incorporating the 3D representations of the missing components into the 3D CAD model of the assembly to create a complete 3D CAD model; and
controlling a manufacturing process for the assembly according to the complete 3D CAD model.

2. The method of claim 1, further comprising generating, from textual information related to the 2D engineering drawings, a sequence of assembly of components within the 3D CAD model of the assembly.

3. The method of claim 1, wherein modeling the 3D representation of the missing components comprises recording macros in CAD systems to document and imitate historically performed standard commands by humans to generate 3D object files from 2D drawings.

4. The method of claim 3, further comprising training an artificial intelligence (AI) model to generate automated CAD macros for generating 3D object files from 2D drawings based on the recorded macros.

5. The method of claim 1, wherein modeling the 3D representation of the missing components comprises:
training an artificial intelligence (AI) model based on UV mapping of a number of 3D models; and
generating, with the trained artificial intelligence model, the 3D representations of the missing components.

6. The method of claim 1, wherein modeling the 3D representation of the missing components comprises using a 3D semi-generative artificial intelligence (AI) model to generate the 3D representations of the missing components, wherein the metadata and textual information provides constraints to the 3D semi-generative AI model.

7. The method of claim 6, wherein the 3D semi-generative artificial intelligence model is trained by:
generating a first reduced resolution representation of a 3D training CAD model;
generating a second reduced resolution representation of the 3D training CAD model, wherein the second reduced resolution representation has a higher relative resolution than the first reduced resolution representation;
training a first autoencoder to reconstruct the training CAD model from the first reduced resolution 3D representation; and
training a second autoencoder to reconstruct the training CAD model from the second reduced resolution 3D representation.

8. The method of claim 7, further comprising:
generating a metadata embedding in vector space from the 2D engineering drawings;
generating image embeddings in latent space of the 2D engineering drawings; and
training a coarse transformer, according to the metadata and image embeddings, to reconstruct low resolution code from partially masked low resolution code, wherein the reconstructed low resolution code is used by the first autoencoder.

9. The method of claim 8, further comprising:
training a fine transformer, according to the generated low resolution code, to reconstruct high resolution code from partially masked high resolution code, wherein the reconstructed high resolution code is used by the second autoencoder.

10. The method of claim 6, wherein the 3D semi-generative AI model:
receives input of a metadata embedding in vector space based on the 2D engineering drawings;
receives input of image embeddings in latent space based on the 2D engineering drawings;
receives input of a number of prompts that specify desired material characteristics of the 3D representations of the missing components;
generates, with a coarse transformer according to the metadata embedding, image embeddings, and prompt, unmasked low resolution code from masked low resolution code;
generates, with a fine transformer based on the unmasked low resolution code, unmasked high resolution code from masked high resolution code; and
generates, with a voxel decoder, the 3D representations of the missing components based on the unmasked high resolution code.

11. A system for generating a 3D model from 2D drawings, the system comprising:
a storage device that stores program instructions;
one or more processors operably connected to the storage device and configured to execute the program instructions to cause the system to:
extract, by a design parser, content from 2D engineering drawings of an assembly;
compare the extracted content to a bill of materials corresponding to a 3D computer assisted design (CAD) model of the assembly to identify missing components from the 3D CAD model;
responsive to identifying missing components, model 3D representations of the missing components based on the 2D engineering drawings, and metadata and textual information related to the 2D engineering drawings;
incorporate the 3D representations of the missing components into the 3D CAD model of the assembly to create a complete 3D CAD model; and
control a manufacturing process for the assembly according to the complete 3D CAD model.

12. The system of claim 11, wherein the processors further execute instructions to generate, from textual information related to the 2D engineering drawings, a sequence of assembly of components within the 3D CAD model of the assembly.

13. The system of claim 11, wherein modeling the 3D representation of the missing components comprises recording macros in CAD systems to document and imitate historically performed standard commands by humans to generate 3D object files from 2D drawings.

14. The system of claim 13, wherein the processors further execute instructions to train an artificial intelligence (AI) model to generate automated CAD macros for generating 3D object files from 2D drawings based on the recorded macros.

15. The system of claim 11, wherein modeling the 3D representation of the missing components comprises:
training an artificial intelligence (AI) model based on UV mapping of a number of 3D models; and
generating, with the trained artificial intelligence model, the 3D representations of the missing components.

16. The system of claim 11, wherein modeling the 3D representation of the missing components comprises using a 3D semi-generative artificial intelligence (AI) model to generate the 3D representations of the missing components, wherein the metadata and textual information provides constraints to the 3D semi-generative AI model.

17. The system of claim 16, wherein the 3D semi-generative artificial intelligence model is trained by:
generating a first reduced resolution representation of a 3D training CAD model;
generating a second reduced resolution representation of the 3D training CAD model, wherein the second reduced resolution representation has a higher relative resolution than the first reduced resolution representation;
training a first autoencoder to reconstruct the training CAD model from the first reduced resolution 3D representation; and
training a second autoencoder to reconstruct the training CAD model from the second reduced resolution 3D representation.

18. A computer program product for generating a 3D model from 2D drawings, the computer program product comprising:
a computer-readable storage medium having program instructions embodied thereon to perform the operations of:
extracting, by a design parser, content from 2D engineering drawings of an assembly;
comparing the extracted content to a bill of materials corresponding to a 3D computer assisted design (CAD) model of the assembly to identify missing components from the 3D CAD model;
responsive to identifying missing components, modeling 3D representations of the missing components based on the 2D engineering drawings, and metadata and textual information related to the 2D engineering drawings;
incorporating the 3D representations of the missing components into the 3D CAD model of the assembly to create a complete 3D CAD model; and
controlling a manufacturing process for the assembly according to the complete 3D CAD model.

19. The computer program product of claim 18, further comprising instructions for generating, from textual information related to the 2D engineering drawings, a sequence of assembly of components within the 3D CAD model of the assembly.

20. The computer program product of claim 18, wherein modeling the 3D representation of the missing components comprises recording macros in CAD systems to document and imitate historically performed standard commands by humans to generate 3D object files from 2D drawings.

21. The computer program product of claim 20, further comprising instructions for training an artificial intelligence (AI) model to generate automated CAD macros for generating 3D object files from 2D drawings based on the recorded macros.

22. The computer program product of claim 18, wherein modeling the 3D representation of the missing components comprises:
training an artificial intelligence (AI) model based on UV mapping of a number of 3D models; and
generating, with the trained artificial intelligence model, the 3D representations of the missing components.

23. The computer program product of claim 18, wherein modeling the 3D representation of the missing components comprises using a 3D semi-generative artificial intelligence (AI) model to generate the 3D representations of the missing components, wherein the metadata and textual information provides constraints to the 3D semi-generative AI model.

24. The computer program product of claim 23, wherein the 3D semi-generative artificial intelligence model is trained by:
generating a first reduced resolution representation of a 3D training CAD model;
generating a second reduced resolution representation of the 3D training CAD model, wherein the second reduced resolution representation has a higher relative resolution than the first reduced resolution representation;
training a first autoencoder to reconstruct the training CAD model from the first reduced resolution 3D representation; and
training a second autoencoder to reconstruct the training CAD model from the second reduced resolution 3D representation.
